(19) United States
(12) Patent Application Publication
(10) Pub. No.: US 2026/0251592 A1
(43) Pub. Date: Aug. 27, 2026

(54) Sample Holder Configured to Releasably Connect to a Tool

(71) Applicant: Alloy Geek LLC, Fuquay-Varina, NC (US)

(72) Inventor: Nathaniel James Newbury, Cary, NC (US)

(21) Appl. No.: 19/532,068

(22) Filed: Feb. 6, 2026

Related U.S. Application Data
(60) Provisional application No. 63/763,434, filed on Feb. 26, 2025.

(51) Int. Cl. G01N 23/20025

(52) U.S. Cl. CPC G01N 23/20025; G01N 2223/309; G01N 2223/321

(57) ABSTRACT

A holder to position a sample on a tool. The holder includes a receptacle with a holding space that is open to receive the sample. Arms extend outward from the side walls and are spaced apart by a gap with the arms configured to connect to the tool. The arms position the receptacle outward from and in a test field of the tool to enable testing of the sample.

### RELATED APPLICATIONS

This application claims the benefit of U.S. Provisional Application No. 63/763,434, filed on February 26, 2025, and hereby incorporated by reference in its entirety.

### BACKGROUND

There are a number of different tools that are used to analyze a material sample. One example is an x-ray fluorescence (XRF) spectrometer that identifies and measures amounts of different elements in the sample. Other examples of tools include but are not limited to handheld laser induced breakdown spectrometers (LIBS), Raman spectrometers, near-infrared spectrometers (NIR), and various other similar portable scientific spectrometers.

One issue with using these tools is positioning the sample relative to the tool to obtain an accurate reading of the sample. Proper usage includes placing the sample within a field of use of the tool. Further, it can be difficult to hold the sample steady relative to the tool while operating the tool and performing the testing. This is particularly difficult for handheld tools when used in the field as weather conditions and general work conditions can make this difficult. A sample that is misplaced or moving relative to the tool can result in improper readings of the sample. Further, placement of the sample at different positions relative to the tool can result in different results. Thus, a sample positioned at a first position relative to the tool can result in first test results, and positioned at a different second position relative to the tool can result in different second test results.

### SUMMARY

One aspect is directed to a holder to position a sample on a tool. The holder comprises a bottom wall and side walls that extend around a receptacle. The receptacle comprises a holding space that is open to receive the sample. Arms extend outward from the side walls and are spaced apart by a gap with the arms configured to connect to the tool. The arms position the receptacle outward from and in a test field of the tool to enable testing of the sample.

In another aspect, the bottom wall, the side walls, and the arms have a unitary, one-piece construction.

In another aspect, edges of the side walls are spaced apart and form a top side that is open and is in communication with the receptacle with the open side being positioned on an opposing side of the receptacle from the bottom wall.

In another aspect, an opening extends through the bottom wall and is in communication with the receptacle with the opening being spaced away from the side walls.

In another aspect, the side walls are spaced apart and extend along opposing sides of a port with the port positioned vertically above the bottom wall.

In another aspect, the arms are flexible relative to the side walls to flex outward away from one another when the holder is connected to the tool.

In another aspect, a shield is positioned along one or more of the side walls and the bottom wall to prevent or limit x-ray radiation from traveling beyond the receptacle with the shield constructed from a different material than the bottom wall and the side walls.

In another aspect, the shield is connected to an interior of the one or more side walls and the bottom wall.

In another aspect, the shield comprises plates that are positioned along one or mor of the side walls and the bottom wall.

One aspect is directed to a method of testing a sample with the method comprising: positioning a holder at a working end of a tool; positioning a first arm of the holder on a first side of the tool; positioning a second arm of the holder on a second side of the tool; flexing the first arm and the second arm outward away from each other while moving the holder onto the working end of the tool and connecting the holder to the tool; positioning a receptacle that is positioned at an end of the arms within a test field of the tool while the arms are connecting the holder to the tool; and testing a sample that is in the receptacle while the holder is connected to the tool.

In another aspect, the method further comprises positioning a shield that is integrated with the holder around the sample and limiting x-ray radiation from traveling beyond the receptacle while testing the sample.

In another aspect, the method further comprises positioning bosses along the inner sides of the first arm and the second arm within corresponding grooves of the tool and connecting to the holder to the tool.

In another aspect, the method further comprises inserting the sample through an open a top of the receptacle while the holder is connected to the tool.

In another aspect, the method further comprises positioning an opening 36 in a bottom wall 31 of the receptacle below the sample while the holder is connected to the tool.

One aspect is directed to a method of testing a sample with the method comprising: moving a holder onto a working end of a tool; positioning arms of the holder on opposing sides of the tool; flexing the arms outward away from one another while positioning the arms on the opposing sides of the tool; positioning a receptacle of the holder within a test field of the tool while the arms are contacting against the tool; and testing a sample that is in the receptacle while the holder is connected to the tool.

In another aspect, the method further comprises: moving the holder away from the working end of the tool; and releasing the arms from the tool and enabling the arms to flex inward while disconnecting the holder from the tool.

In another aspect, the method further comprises inserting the sample into the receptacle after connecting the holder to the tool.

In another aspect, the method further comprises aligning a port in the receptacle within the test field of the tool.

In another aspect, the method further comprises positioning the sample within a shield that is attached to the receptacle with the shield constructed from a different material than the holder and preventing or limiting x-ray radiation from traveling beyond the receptacle while testing the sample.

One aspect is directed to a holder to position a sample on a tool that comprises a receptacle comprising a holding space to receive the sample. Arms extend outward from the receptacle and are configured to connected to the tool. The arms position the receptacle outward from and in a test field of the tool to enable testing of the sample.

In another aspect, the receptacle and arms have a unitary, one-piece construction.

In another aspect, the receptacle comprises side walls that extend around a bottom wall and with an open top side opposite from the bottom wall to receive and remove the sample from the holding space.

In another aspect, an opening extends through the bottom wall.

In another aspect, the bottom wall has a curved shape.

In another aspect, the side walls include a port positioned upward from the bottom wall with the port positioned between the holding space and the tool when the holder is attached to the tool.

In another aspect, the arms are flexible relative to the receptacle to flex outward when connected to the tool.

In another aspect, a face of the holder is substantially flat to contact against the tool and prevent rotation of the holder relative to the tool.

In another aspect, a shield is connected to the receptacle to prevent or limit x-ray radiation from traveling beyond the receptacle.

One aspect is directed to a holder to position a sample on a tool. The holder comprises a body with: a receptacle with a holding area to receive the sample; arms that extend outward from the receptacle with the arms spaced apart with an intermediate space therebetween that is sized to receive the tool; and wherein the body is flexible for the arms to flex outward when connected to the tool.

One aspect is directed to a method of testing a sample comprising: moving a holder onto a working end of a tool; positioning a first arm of the holder on a first side of the tool; positioning a second arm of the holder on a second side of the tool; connecting the holder to the tool by flexing the arms outward away from each other while moving the holder onto the working end of the tool; positioning a receptacle connected to the arms within a test field of the tool while the arms are connecting the holder to the tool; and testing a sample that is in the receptacle while the holder is connected to the tool.

In another aspect, a shield is connected to the receptacle to prevent or limit x-ray radiation from traveling beyond the receptacle.

One aspect is directed to a method of testing a sample comprising: moving a holder onto a working end of a tool and positioning arms of the holder on opposing sides of the tool; positioning a receptacle connected to the arms within a test field of the tool while the arms are contacting against the tool; and testing a sample that is in the receptacle while the holder is connected to the tool.

In another aspect, the method further comprises: moving the holder away from the working end of the tool; enabling the arms to flex inward while moving the holder; and disconnecting the holder from the tool.

In another aspect, the method further comprises inserting the sample into the receptacle after connecting the holder to the tool.

In another aspect, connecting the holder to the tool comprises inserting bosses on the arms into grooves on the tool.

In another aspect, the method further comprises releasing the holder and maintaining the holder connected to the tool through the arms contacting against the tool.

In another aspect, the method further comprises aligning a port in the receptacle within the test field of the tool.

In another aspect, the method further comprises attaching the holder and preventing rotation of the holder relative to the tool.

In another aspect, the method further comprises positioning the sample within a shield that is attached to the receptacle.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a holder configured to hold a sample and to connect to a tool.

FIG. 2 is an isometric view of a holder.

FIG. 3 is a top view of the holder of FIG. 2.

FIG. 4 is a bottom view of the holder of FIG. 2.

FIG. 5 is an isometric view of a holder connected to a tool.

FIG. 6 is a top view of the holder and tool of FIG. 5.

FIG. 7 is a flowchart diagram of a method of testing a sample.

FIG. 8 is a flowchart diagram of a method of testing a sample.

FIG. 9 is a top view of a holder that includes a coating attached to one or more of the walls and bottom of the receptacle.

FIG. 10 is a top view of a holder that includes one or more plates attached to one or more of the walls and bottom of the receptacle.

The various aspects of the various embodiments may be used alone or in any combination, as is desired.

### DETAILED DESCRIPTION

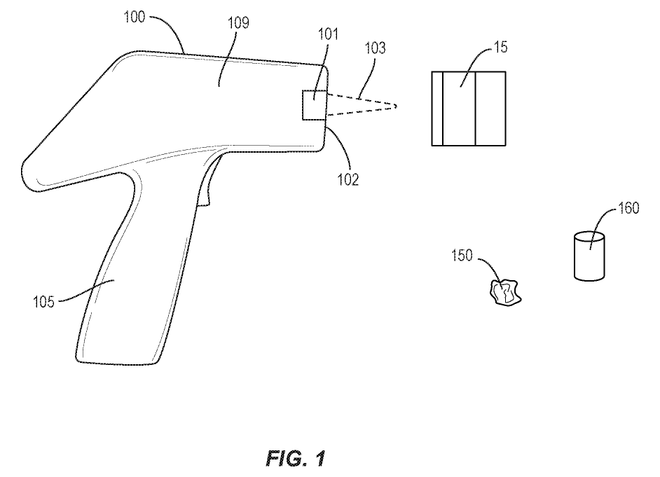

FIG. 1 illustrates a holder 15 configured to receive a sample 150 that is to be tested. The holder 15 is further configured to connect to a tool 100. The holder 15 positions the sample 150 within a test field 103 located outward beyond an end 102 of the tool 100. The tool 100 includes a detector 101 and is configured to determine aspects of the sample 150.

The tool 100 is relatively small to enable handling by an operator (i.e., a hand-held device). The tool 100 includes a body 109 with a handle 105 to facilitate the manual operation. The body 109 includes a working end 102 at the detector 101. The test field 103 is formed by the detector 101 and is positioned outward from the working end 102. The size of the test field 103 and the position relative to the working end 102 can vary. In some examples, the test field 103 extends outward from the working end 102 with samples positioned closer to the working end 102 having the highest instrument sensitivity.

The holder 15 can be used with a variety of different tools 100. In some examples, the tool 100 is an X-ray fluorescence (XRF) spectrometer. In this example, the detector 101 emits x-rays (i.e., primary x-rays) that excite the sample 150 and causes the sample 150 to emit x-rays (i.e., secondary x-rays). The detector 101 is configured to detect the secondary x-rays. The tool 100 is configured to convert the detected secondary x-rays into quantitative and/or qualitative spectra to identify aspects of the sample 150, including but not limited to the elements that are in the sample 150, the grade of material in the sample 150, and trace, minor, and major elements in alloys.

The holder 15 is configured to hold a variety of different samples 150. In some examples, the sample 150 includes one or more soil, rocks, minerals, sediments, and fluids. In other examples, the sample 150 includes consumer goods (e.g., plastic toys), coated/plated components, lead paint, geochemical samples, precious metal samples (e.g., gold, various platinum group metals), circuit boards, electrical components, automative catalytic converter material, concrete, fluid, and various industrial components. In some examples, the sample 150 is placed directly into the holder 15. In other examples, the sample 150 is initially placed in a container 160. The container 160 with the sample 150 is then placed into the holder 15. The container 160 has a transparent window for the test field 103 to enable the tool 100 to analyze the sample 150. In some examples, the container 160 has an enclosed interior space to hold the sample that is in the form of a powder or liquid. The interior space of the container 160 is also configured to hold a sample that is a solid.

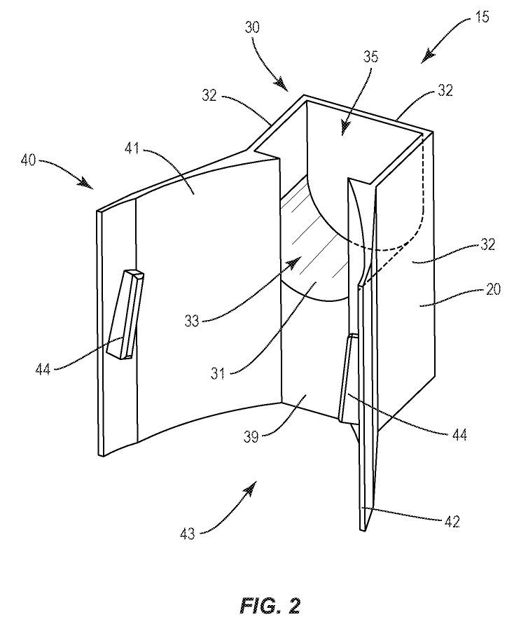

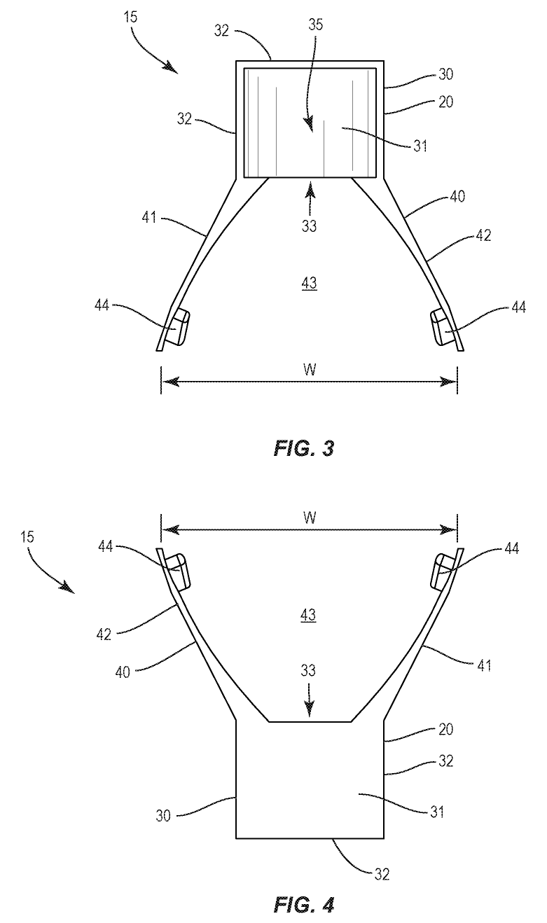

The holder 15 is configured to hold the sample 150 and connect to the tool 100. FIGS. 2, 3, and 4 illustrate a holder 15 that includes a body 20 with a receptacle 30 configured to hold the sample 150, and arms 40 configured to connect to the tool 100. In some examples, the body 20 has a unitary, one-piece construction. In other examples, the body 20 is constructed from two or more pieces that are connected together, such as but not limited to being connected together by adhesives, bonding, and mechanical fasteners. The body 20 can be constructed from a variety of materials, including but not limited to polymers (e.g., polyactic acid (PLA), polyethylene terephthalate glycol (PETG), polycarbonate (PC)), and metals (e.g., stainless steel). In some examples, the polymers are impregnated with carbon fibers to reinforce the structure. In some examples, the polymers are impregnated with metal particles to reinforce the structure and/or absorb x-ray radiation.

The receptacle 30 is configured to contain the sample 150. The receptacle 30 includes a bottom wall 31 and side walls 32. The walls 31, 32 can include a variety of shapes and sizes. A holding space 35 is formed between the bottom wall 31 and the side walls 32. The holding space 35 is configured to receive the sample 150. The holding space 35 is open at the top to enable the sample 150 to be inserted and removed.

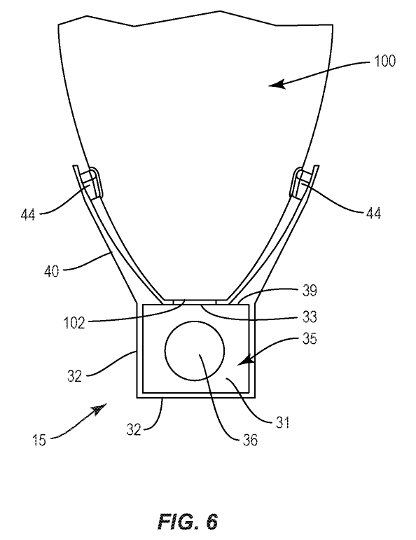

The bottom wall 31 is positioned at the bottom of the side walls 32 and supports the sample 150. In some examples, the bottom wall 31 is continuous. In other examples, the bottom wall 31 includes an opening 36 that facilitates removal of the sample 150 from the holding space 35. In some examples, the opening 36 enables the user to push the container 160 away from the bottom wall 31 and through the open top (see FIG. 6). In some examples as illustrated in FIG. 2, the bottom wall 31 has a curved shape to facilitate positioning the container 160 to align the sample 150 in the vertical direction relative to the detector 101. In other examples, the bottom wall 31 is configured to match the geometry of the sample 150 and/or container 160.

The receptacle 30 includes a port 33 along one or more of the sides. The port 33 is positioned towards the tool 100 when the holder 15 is attached and enables direct line of sight and alignment with the detector 101. The port 33 enables the detector 101 to emit and receive signals directly to and from the sample 150 without passing through a wall of the holder 15. In some examples, the port 33 extends along the entirety of one or more sides 32 of the holding space 35. In other examples, the port 33 extends along a limited section of one of the sides 32 of the holding space 35. The port 33 also provides for alignment of the holder 15 and the tool 100. Alignment of the port 33 ensures direct line-of-sight between the tool 100 and the sample 150 that is positioned in the receptacle 30.

The arms 40 are configured to removably connect to the tool 100. The arms 40 include a first arm 41 and a second arm 42 that each extend outward from the receptacle 30. The arms 41, 42 can include the same shape and size, or can have different shapes and/or sizes. The arms 41, 42 are spaced apart with a gap 43 formed between. The gap 43 includes a width W measured between the arms 41, 42. In some examples, the arms 41, 42 angle outward such that the width W increases away from the receptacle 30. This tapered shape facilitates mounting the arms 40 to the tool 100. In other examples, the arms 41, 42 are substantially parallel with the width W being substantially the same throughout the gap 43.

The arms 41, 42 are configured to connect to the tool 100. The arms 41, 42 are flexible to flex outward away from each other when mounted to the tool 100. This configuration causes the arms 41, 42 to apply a compressive force against the tool 100 to connect the holder 15. In some examples, the gap 43 has a default width W (i.e., a width when no forces are applied to the arms 40). This default width W is less than a width of the body 109 of the tool 100 at the working end 102. The arms 41, 42 are configured to flex outward to enlarge the width W of the gap 43 when the holder 15 is positioned on the tool 100. This flexing causes the arms 41, 42 to flex outward away from each other and apply a compressive force to the body 109 to connect the holder 15 to the tool 100. Additionally or alternatively, the arms 41, 42 include one or more bosses 44 that extend outward from an inner side. The bosses 44 are configured to engage with the tool 100 to provide for the connection. In some examples, the arms 40 are configured to apply a compressive force against the tool 100 while the bosses 44 are configured to provide mechanical engagement with the tool 100.

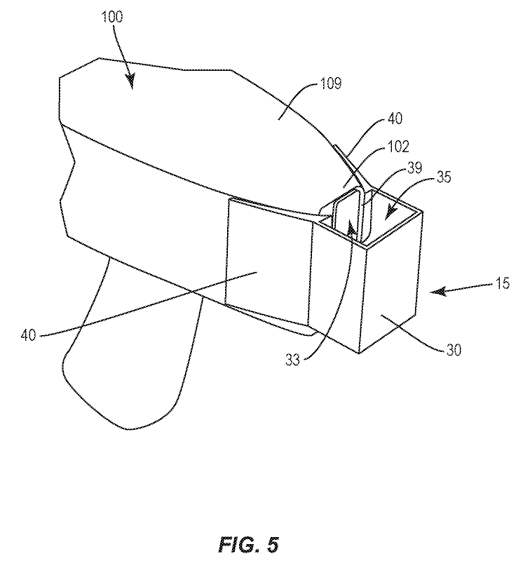

The arms 40 are configured to connect to the tool 100 in different manners provided the arms 40 enable the receptacle 30 to be positioned within the test field 103. In some examples as illustrated in FIGS. 5 and 6, the arms 40 are configured to engage opposing lateral sides of the tool 100. Other examples include the arms 40 engaging different sections of the tool 100, such as but not limited to engaging upper and lower surfaces of the tool 100. In the various examples, the external surfaces of the tool 100 that are engaged by the arms 40 can include various shapes, sizes, and configurations.

In some examples, the arms 40 apply just a compressive force to connect to the tool 100. In other examples, the arms 40 are configured to just be mechanically connected to the tool 100. In other examples, the arms 40 are configured to connect to the tool 100 with both compressive and mechanical means.

FIGS. 5 and 6 illustrate the holder 15 connected to the tool 100. The arms 40 are positioned on opposing sides of the body 109 of the tool 100 at the working end 102. Bosses 44 on the inner sides of the arms 40 engage with edges that extend along the sides of the tool 100. The receptacle 30 is positioned outward beyond the working end 102 of the tool 100. The port 33 faces towards the working end 102 and is aligned with the detector (not illustrated) to position the holding space 35 within the test field 103 of the tool 100.

The arms 40 maintain the holder 15 connected to the tool 100. In some examples, the sample 150 is placed in the receptacle 30 after the holder 15 is connected to the tool 100. In other examples, the sample 150 is positioned in the receptacle 30, and then the holder 15 is connected to the tool 100. With the holder 15 and sample 150 positioned, the user is able to use the tool 100 to perform testing on the sample 150. Once the testing is complete, the sample 150 can be removed from the holder 15 either while the holder 15 is attached to the tool 100, or after the holder 15 is detached.

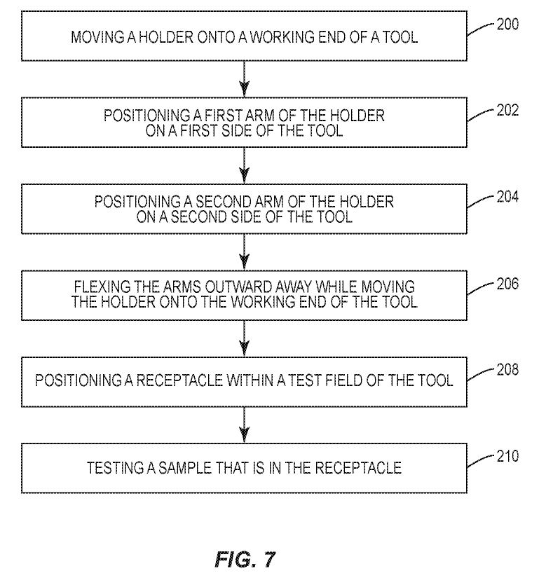

FIG. 7 illustrates a method of testing a sample 150. The method includes moving a holder 15 onto a working end 102 of a tool 100 (block 200). A first arm 41 is positioned on a first side of the tool 100 (block 202) and a second arm 42 is positioned on a second side of the tool 100 (block 204). The arms 41, 42 flex outward away from each other while moving the holder 15 onto the working end 102 of the tool (block 206). A receptacle 30 of the holder 15 is positioned within a test field 103 of the tool 100 while the arms 41, 42 are connecting the holder 15 to the tool 100 (block 208). With the holder 15 connected to the tool 100, testing a sample 150 that is in the receptacle 30 (block 210).

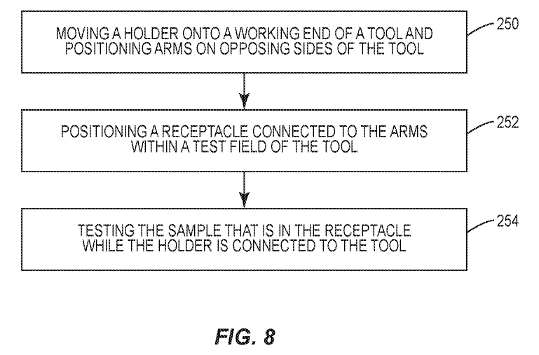

FIG. 8 illustrates another method of testing a sample. The holder 15 is moved onto the tool 100 and arms 41, 42 are positioned on opposing sides of the tool 100 (block 250). A receptacle 30 that is connected to the arms 41, 42 is positioned within a test field 103 of the tool 100 by the arms 41, 42 that are contacting against the tool 100 (block 252). A sample 150 that is in the receptacle 30 is then tested by the tool 100 (block 254).

The holder 15 is further designed to prevent rotation relative to the tool 100. In some examples, the arms 40 and bosses 44 maintain the connection to prevent rotation. In some examples as illustrated in FIG. 2, 5, and 6, the face 39 of the receptacle 30 is positioned in proximity to the port 33 to contact against the working end 102 of the tool 100. In some examples, the face 39 is substantially flat to contact against the corresponding flat working end 102 when the holder 15 is mounted to the tool. In other examples, the face 39 includes other shapes that correspond to the working end 102 to contact against and prevent rotation.

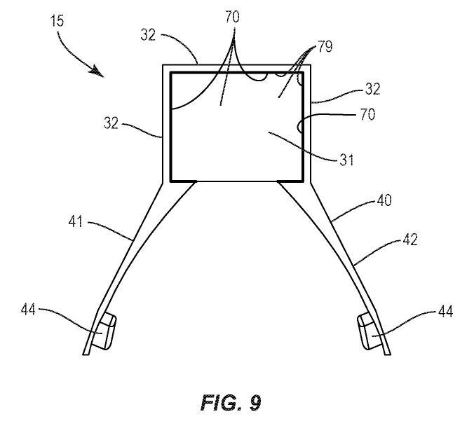

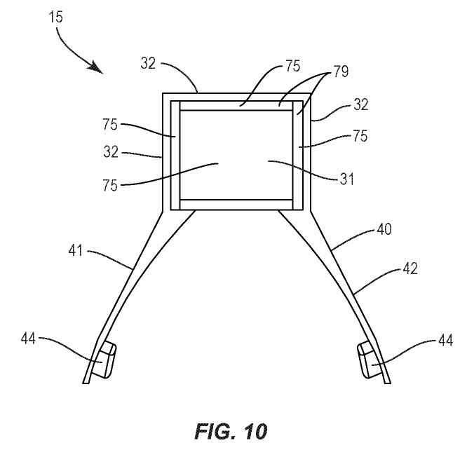

In some examples, the holder 15 is designed to absorb and/or prevent the x-ray radiation from traveling beyond the receptacle 30. This can be accomplished by constructing the receptacle 30 and/or the entire holder 40 from material that is able to perform this function. Example of materials include but are not limited to various metals and polymers that are embedded with metal particles. Additionally or alternatively, a shield 79 is positioned at the receptacle 30. The shield 79 can include a variety of different radiation attenuating structures. In some examples as illustrated in FIG. 9, the shield 79 includes a coating 70 on one or more of the surfaces of the holder 15. In one specific example, the coating 70 is on one or more of the side walls 32 and bottom 31 of the receptacle 30. In some examples as illustrated in FIG. 10, the shield 79 includes plates 75 that are connected to the holder 15 and positioned along one or more of the side walls 32 and bottom 31. In some examples, the size and shape of the plates 75 substantially corresponds to the side walls 32 and/or bottom 31 to facilitate positioning. In some examples, the shield 79 includes two or more of the materials, coating, and plates.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are second ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A holder to position a sample on a tool, the holder comprising:
a bottom wall and side walls that extend around a receptacle, wherein the receptacle comprises a holding space that is open to receive the sample;
arms that extend outward from the side walls and that are spaced apart by a gap with the arms configured to contact against opposing sides of the tool; and
wherein the arms connect the holder to the tool and position the receptacle outward from and in a test field of the tool to enable testing of the sample.

2. The holder of claim 1, wherein the bottom wall, the side walls, and the arms have a unitary, one-piece construction.

3. The holder of claim 1, wherein edges of the side walls are spaced apart and form a top side that is open and is in communication with the receptacle with the open side being positioned on an opposing side of the receptacle from the bottom wall.

4. The holder of claim 3, further comprising an opening that extends through the bottom wall and is in communication with the receptacle, the opening being spaced away from the side walls.

5. The holder of claim 1, wherein the side walls are spaced apart and extend along opposing sides of a port with the port positioned vertically above the bottom wall.

6. The holder of claim 1, wherein the arms are flexible relative to the side walls to flex outward away from one another when the holder is connected to the tool.

7. The holder of claim 6, further comprising bosses that extend outward from the arms, wherein the arms flex to provide a compressive force and the bosses engage with the tool to provide mechanical connections with the tool.

8. The holder of claim 1, further comprising a shield positioned along one or more of the side walls and the bottom wall to prevent or limit x-ray radiation from traveling beyond the receptacle with the shield constructed from a different material than the bottom wall and the side walls.

9. The holder of claim 8, wherein the shield is connected to an interior of the one or more side walls and the bottom wall.

10. The holder of claim 8, wherein the shield comprises plates that are positioned along one or mor of the side walls and the bottom wall.

11. The holder of claim 1, further comprising a container having a contained interior space sized to receive the sample, wherein the container is further sized to fit within the receptacle to position the sample relative to the tool to enable the testing of the sample.

12. A method of testing a sample, the method comprising:
positioning a holder at a working end of a tool;
positioning a first arm of the holder on a first side of the tool;
positioning a second arm of the holder on a second side of the tool;
flexing the first arm and the second arm outward away from each other while moving the holder onto the working end of the tool and connecting the holder to the tool;
positioning a receptacle that is positioned at an end of the arms within a test field of the tool while the arms are connecting the holder to the tool; and
testing a sample that is in the receptacle while the holder is connected to the tool.

13. The method of claim 12, further comprising positioning a shield that is integrated with the holder around the sample and limiting x-ray radiation from traveling beyond the receptacle while testing the sample.

14. The method of claim 12, further comprising inserting the sample through an open a top of the receptacle while the holder is connected to the tool and positioning an opening in a bottom wall of the receptacle below the sample while the holder is connected to the tool.

15. The method of claim 12, further comprising:
placing the sample in a container;
positioning the sample and the container within the receptacle; and
testing the sample while the sample is within the container.

16. A method of testing a sample, the method comprising:
moving a holder onto a working end of a tool;
positioning arms of the holder on opposing sides of the tool;
flexing the arms outward away from one another while positioning the arms on the opposing sides of the tool and applying a compressive force to connect the holder to the tool;
positioning a receptacle of the holder within a test field of the tool while the arms are contacting against the tool; and
testing a sample that is in the receptacle while the holder is connected to the tool.

17. The method of claim 16, further comprising:
moving the holder away from the working end of the tool; and
releasing the arms from the tool and enabling the arms to flex inward while disconnecting the holder from the tool.

18. The method of claim 16, further comprising inserting the sample into the receptacle 30 after connecting the holder to the tool.

19. The method of claim 16, further comprising aligning a port in the receptacle within the test field of the tool.

20. The method of claim 16, further comprising positioning the sample within a shield that is attached to the receptacle with the shield constructed from a different material than the holder and preventing or limiting x-ray radiation from traveling beyond the receptacle while testing the sample.
